(19) United States
(12) Patent Application Publication
(10) Pub. No.: US 2017/0131989 A1
(43) Pub. Date: May 11, 2017

(54) INSTALLATION INTERFACE PRESENTATION METHOD AND APPARATUS

(71) Applicant: TENCENT TECHNOLOGY (SHENZHEN) COMPANY LIMITED, Shenzhen, Guangdong (CN)

(72) Inventors: Jiongchen HE, Shenzhen (CN); Jian DU, Shenzhen (CN); Weibin PAN, Shenzhen (CN); Xiao YANG, Shenzhen (CN)

(21) Appl. No.: 15/317,696

(22) PCT Filed: Jun. 9, 2015
(86) PCT No.: PCT/CN2015/081097

§ 371 Date: Dec. 9, 2016

(30) Foreign Application Priority Data
Jun. 9, 2014 (CN) 201410253414.5

(51) Int. Cl. G06F 9/445; G06F 9/44

(52) U.S. Cl. CPC G06F 8/61; G06F 9/4443

(57) ABSTRACT

Disclosed is an installation interface presentation method and apparatus. The method includes: performing an i^{th} cutting operation on an (i−1)^{th} installation interface of an application program in a process of installing the application program, 1≦i≦j; determining a reserved i^{th} installation interface after the i^{th} cutting operation is completed; replacing the (i−1)^{th} installation interface with the i^{th} installation interface, and presenting the i^{th} installation interface; and updating i with i+1, and proceeding to perform the step of performing an i^{th} cutting operation on an (i−1)^{th} installation interface of an application program. A related apparatus is also provided.

### FIELD OF THE TECHNOLOGY

The present disclosure relates to the field of computer technologies, and in particular, to an installation interface presentation method and apparatus.

### BACKGROUND OF THE DISCLOSURE

When a terminal runs an installation package of an application program to install the application program, an installation interface of the application program is generally presented in a process of installation, and the installation interface is used to present information of the application program.

An existing installation interface presentation method includes: in a process in which a terminal runs an installation package of an application program, drawing a progress bar used for presenting an installation progress on an installation interface of the application program; acquiring the installation progress of the application program every other predetermined time; and drawing the acquired installation progress into the progress bar.

In a process of implementing the present disclosure, because the terminal needs to update the installation progress of the application program in the progress bar in real time, the terminal needs to draw the installation progress into the progress bar every time the terminal acquires the installation progress, and drawings for multiple times consume a great number of processing resources of the terminal.

### SUMMARY

In order to solve a problem of consuming a great number of processing resources of a terminal when the terminal draws an installation progress of an application program into a progress bar for multiple times, embodiments of the present invention provide an installation interface presentation method and apparatus. The technical solutions are described as follows.

According to one aspect, an embodiment of the present invention provides an installation interface presentation method, including:

performing an i^{th} cutting operation on an (i−1)^{th} installation interface of an application program in a process of installing the application program, 1≦i≦j;

determining a reserved i^{th} installation interface after the i^{th} cutting operation is completed;

replacing the (i−1)^{th} installation interface with the i^{th} installation interface, and presenting the i^{th} installation interface; and

updating i with i+1, and proceeding to perform the step of performing an i^{th} cutting operation on an (i−1)^{th} installation interface of an application program.

According to another aspect, an embodiment of the present invention provides an installation interface presentation apparatus, including:

an interface cutting module, configured to perform an i^{th} cutting operation on an (i−1)^{th} installation interface of an application program in a process of installing the application program, 1≦i≦j;

an interface determining module, configured to determine a reserved i^{th} installation interface after the interface cutting module completes the i^{th} cutting operation;

an interface presentation module, configured to replace the (i−1)^{th} installation interface with the i^{th} installation interface determined by the interface determining module, and present the i^{th} installation interface; and

an operation cycling module, configured to update i with i+1, and proceed to perform the operation of performing an i^{th} cutting operation on an (i−1)^{th} installation interface of an application program.

An i^{th} cutting operation is performed on an (i−1)^{th} installation interface of an application program in a process of installing the application program; a reserved i^{th} installation interface is determined after the i^{th} cutting operation is completed; the (i−1)^{th} installation interface is replaced with the i^{th} installation interface, and the i^{th} installation interface is presented; and i is updated with i+1, and the step of performing an i^{th} cutting operation on an (i−1)^{th} installation interface of an application program proceeds to be performed. An installation interface can be gradually decreased by cutting the installation interface of the application program, and a speed of an installation progress is embodied by using a size of the installation interface. Because the number of times of replacing the installation interface is much less than the number of times of drawing the installation progress into a progress bar, a problem of consuming a great number of processing resources of a terminal when the terminal draws the installation progress of the application program into the progress bar for multiple times is solved, and an effect of saving the processing resources of the terminal is achieved.

### BRIEF DESCRIPTION OF THE DRAWINGS

To describe the technical solutions of embodiments of the present invention more clearly, the following briefly introduces the accompanying drawings required for describing the embodiments. Apparently, the accompanying drawings in the following description show only some embodiments of the present invention, and a person of ordinary skill in the art may still derive other drawings from these accompanying drawings without creative efforts.

FIG. 1 is a method flowchart of an installation interface presentation method according to an embodiment of the present invention;

FIG. 2A is a method flowchart of an installation interface presentation method according to another embodiment of the present invention;

FIG. 2B is a schematic diagram of a first interface of an installation interface presentation method according to an embodiment of the present invention;

FIG. 2C is a schematic diagram of a second interface of an installation interface presentation method according to an embodiment of the present invention;

FIG. 2D is a schematic diagram of a third interface of an installation interface presentation method according to an embodiment of the present invention;

FIG. 2E is a schematic diagram of a fourth interface of an installation interface presentation method according to an embodiment of the present invention;

FIG. 2F is a schematic diagram of a fifth interface of an installation interface presentation method according to an embodiment of the present invention;

FIG. 2G is a schematic diagram of a sixth interface of an installation interface presentation method according to an embodiment of the present invention;

FIG. 2H is a schematic diagram of a seventh interface of an installation interface presentation method according to an embodiment of the present invention;

FIG. 2I is a schematic diagram of an eighth interface of an installation interface presentation method according to an embodiment of the present invention;

FIG. 3 is a structural block diagram of an installation interface presentation apparatus according to an embodiment of the present invention; and

FIG. 4 is a structural block diagram of an installation interface presentation apparatus according to another embodiment of the present invention;

FIG. 5 shows a structural block diagram of an installation interface presentation apparatus 1100 according to an embodiment of the present invention.

### DESCRIPTION OF EMBODIMENTS

To make the objectives, technical solutions, and advantages of the present disclosure clearer, the following further describes the embodiments of the present invention in detail with reference to the accompanying drawings.

Referring to FIG. 1, FIG. 1 shows a method flowchart of an installation interface presentation method according to an embodiment of the present invention. The installation interface presentation method can be applied to a terminal, where the terminal may be a smart TV, a smartphone, a tablet computer, or the like. The installation interface presentation method includes:

Step 101: Perform an i^{th} cutting operation on an (i−1)^{th} installation interface of an application program in a process of installing the application program, where 1≦i≦j.

The installation interface refers to an interface that presents installation information of the application program in the terminal in the process of installing the application program. The installation information may include a name, an icon, a use protocol, and a function introduction of the application program, and the like.

The (i−1)^{th} installation interface refers to an installation interface presented in the terminal before the i^{th} cutting is performed.

J is the total number of times of cutting the installation interface of the application program. For example, when j=3, the installation interface of the application program is cut for three times.

Step 102: Determine a reserved i^{th} installation interface after the i^{th} cutting operation is completed.

The terminal may store installation interfaces, find an installation interface corresponding to the i^{th} cutting from the stored installation interfaces after the i^{th} cutting operation is completed, and determine that the installation interface is the reserved i^{th} installation interface.

Step 103: Replace the (i−1)^{th} installation interface with the i^{th} installation interface, and present the i^{th} installation interface.

The terminal presents the acquired i^{th} installation interface to replace the (i−1)^{th} installation interface presented formerly.

Step 104: Update i with i+1, and proceed to perform the step of performing an i^{th} cutting operation on an (i−1)^{th} installation interface of an application program.

When i<j, i is updated with i+1, and the performing the cutting operation on the (i−1)^{th} installation interface proceeds; and when i=j, i is updated with a value of i+1 and the value is greater than j. At this moment, a cutting process ends.

In summary, in the installation interface presentation method according to this embodiment of the present invention, an i^{th} cutting operation is performed on an (i−1)^{th} installation interface of an application program in a process of installing the application program; a reserved i^{th} installation interface is determined after the i^{th} cutting operation is completed; the (i−1)^{th} installation interface is replaced with the i^{th} installation interface, and the i^{th} installation interface is presented; and i is updated with i+1, and the step of performing an i^{th} cutting operation on an (i−1)^{th} installation interface of an application program proceeds to be performed. An installation interface can be gradually decreased by cutting the installation interface of the application program, and a speed of an installation progress is embodied by using a size of the installation interface. Because the number of times of replacing the installation interface is much less than the number of times of drawing the installation progress into a progress bar, a problem of consuming a great number of processing resources of a terminal when the terminal draws the installation progress of the application program into the progress bar for multiple times is solved, and an effect of saving the processing resources of the terminal is achieved.

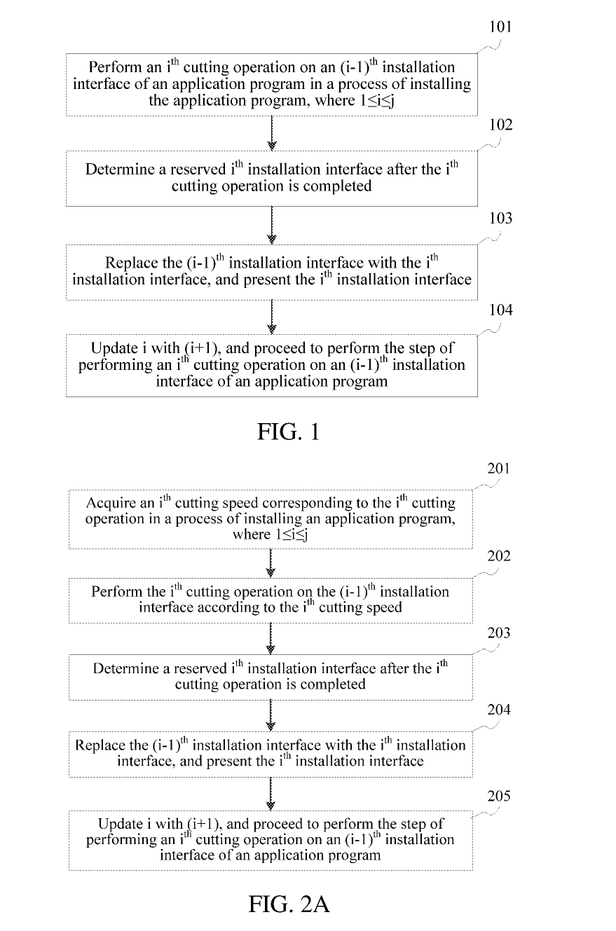

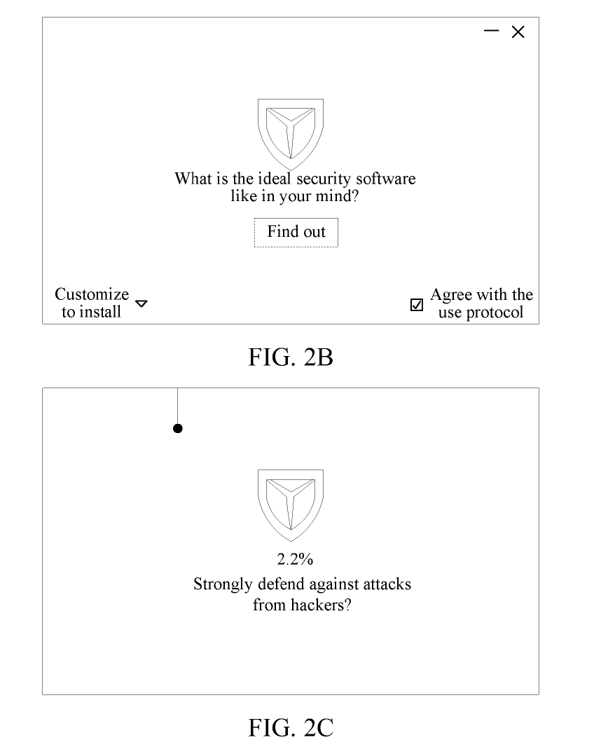

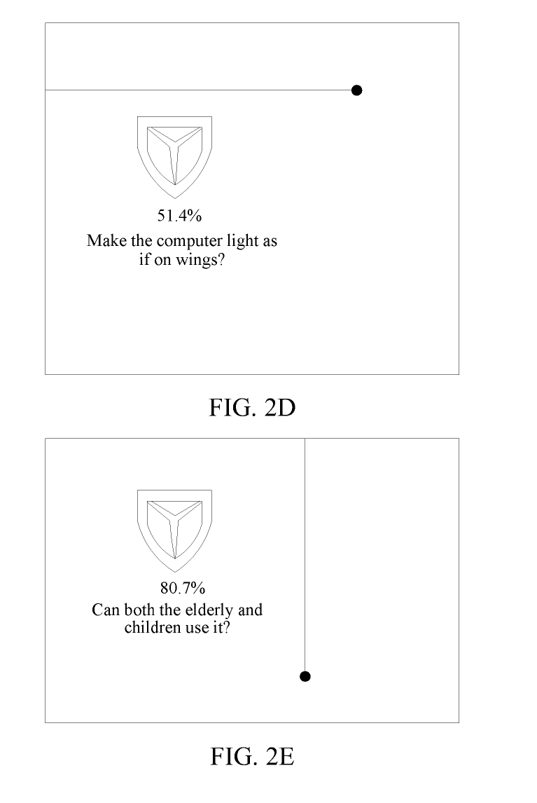

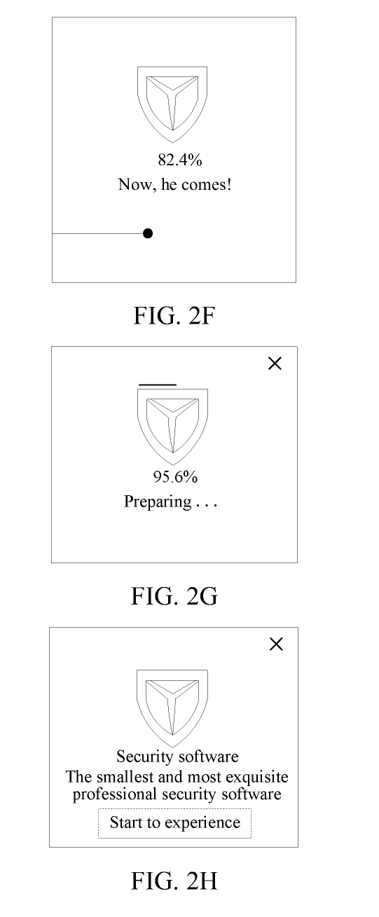

Referring to FIG. 2A, FIG. 2A shows a method flowchart of an installation interface presentation method according to another embodiment of the present invention. The installation interface presentation method can be applied to a terminal, where the terminal may be a smart TV, a smartphone, a tablet computer, or the like. The installation interface presentation method includes:

Step 201: Acquire an i^{th} cutting speed corresponding to an i^{th} operation in a process of installing an application program, where 1≦i≦j.

In this embodiment, an installation progress of the application program is embodied by cutting an installation interface in the process of installing the application program. The installation interface refers to an interface that presents installation information of the application program in the terminal in the process of installing the application program. The installation information may include a name, an icon, a use protocol, and a function introduction of the application program, and the like.

The terminal may set the same cutting speed for a cutting operation each time, and then the terminal may acquire a cutting speed for this time before performing the cutting operation each time, and may also use a cutting speed acquired when performing a 1^{st} cutting operation as a cutting speed each time.

The terminal may also set different cutting speeds for the cutting operation each time, and then the acquiring an i^{th} cutting speed corresponding to an i^{th} cutting operation includes:

1) searching a first correspondence for a cutting speed corresponding to i, and determining that the found cutting speed is the i^{th} cutting speed correspond to the i^{th} cutting operation; and/or

2) acquiring an installation progress of the application program, searching a second correspondence for a cutting speed corresponding to the installation progress, and determining that the found cutting speed is the i^{th} cutting speed correspond to the i^{th} cutting operation.

There are multiple methods for acquiring a cutting speed by the terminal. This embodiment is described by merely using two of the methods as examples, and details are as follows.

A first cutting speed acquiring method is that: the terminal presets the first correspondence, where the first correspondence stores a correspondence between i and the cutting speed; and the terminal can search the first correspondence for the cutting speed corresponding to i when performing the i^{th} cutting operation, and determine that the found cutting speed is the i^{th} cutting speed.

For example, the first correspondence stores “1-3 cm/s”, “2-1 cm/s”, “3-1.5 cm/s”, and “4-6 cm/s”. It is assumed that what is performed is the 2^{nd} cutting operation. The terminal finds in the first correspondence that “2” is corresponding to a cutting speed of “1 cm/s”, and uses “1 cm/s” as the 2^{nd} cutting speed.

A second cutting speed acquiring method is that: because processing capabilities of different terminals are different, and the stronger a processing capability is, the faster an installation speed of an application program is, the different terminals have different installation speeds for a same application program. In order to make a cutting process more approximate to an actual process in which the application program is installed in the terminal, the terminal may further adjust the cutting speed according to the installation progress, so as to improve accuracy of cutting.

The terminal presets the second correspondence, where the second correspondence stores a correspondence between the installation progress and the cutting speed; and the terminal can acquire the installation progress of the application program when performing the i^{th} cutting operation, search the second correspondence for the cutting speed corresponding to the installation progress, and determine that the found cutting speed is the i^{th} cutting speed, where the second correspondence may be obtained through calculation according to a predetermined formula, and may also be set according to an empirical value.

For example, the second correspondence stores “1%-10%−1 cm/s”, “11%˜30%−1.5 cm/s”, “31%˜70%−4 cm/s”, and “71%˜100%−6 cm/s”. It is assumed that the acquired current installation progress of the application program is “50%” when the 2^{nd} cutting operation is performed. The terminal finds in the second correspondence that “50%” is corresponding to “4 cm/s”, and uses “4 cm/s” as the 2^{nd} cutting speed.

The terminal may further combine the two cutting speed acquiring methods described above, and acquire the cutting speed by using the combined method. For example, the terminal may use the first method to acquire the cutting speed when i≦m, and use the second method to acquire the cutting speed when i>m; or the terminal may use the first method to acquire the cutting speed when i≧n, and use the second method to acquire the cutting speed when i<n; or the terminal may use the first method to acquire the cutting speed when i≦m or i≧n, and use the second method to acquire the cutting speed when m<i<n, where m≧1 and n≦j. Certainly, the terminal may further use another combination manner, which is not limited in this embodiment. J is the total number of times of cutting the installation interface of the application program. For example, when j=3, the installation interface of the application program is cut for three times.

Psychologists make a research and find that a memory of a user for experience of something is experience at peak time and end time. However, a proportion of good experience and bad experience in a process, and time lengths of the good experience and the bad experience have little effect on the memory. Based on the research described above, it can be known that experience of a user for the installation speed mainly relies on a cutting speed for predetermined times when installation starts and a cutting speed for predetermined times when the installation ends. Therefore, in order to improve the experience of a user for the installation speed, the terminal can increase the cutting speed for predetermined times when the installation starts and/or increase the cutting speed for predetermined times when the installation ends.

Specifically, the i^{th} cutting speed when i≦m is greater than the i^{th} cutting speed when m<i<n; and/or the i^{th} cutting speed when i≧n is greater than the i^{th} cutting speed when m<i<n. Further, the i^{th} cutting speed when i≧n is greater than the i^{th} cutting speed when i≦m.

It is assumed that m=1; n=j=4; the first correspondence stores “1−x cm/s” and “4-2x cm/s”; and the second correspondence stores “1%˜50%−0.3x cm/s” and “51%˜100%−0.5x cm/s”. The terminal determines that the 1^{st} cutting speed is “x cm/s” according to the first correspondence; determines that the 2^{nd} cutting speed is “0.3x cm/s” according to the second correspondence if the acquired installation progress is “42%” when the 2^{nd} cutting operation is performed; determines that the 3^{rd} cutting speed is “0.5x cm/s” according to the second correspondence if the acquired installation progress is “69%” when the 3^{rd} cutting operation is performed; and at last determines that the 4^{th} cutting speed is “2x cm/s” according to the first correspondence.

Step 202: Perform the i^{th} cutting operation on the (i−1)^{th} installation interface according to the i^{th} cutting speed.

The (i−1)^{th} installation interface refers to an installation interface presented in the terminal before the i^{th} cutting is performed.

Specifically, the performing the i^{th} cutting operation on the (i−1)^{th} installation interface according to the i^{th} cutting speed includes:

1) generating a cutting origin in a predetermined location on one boundary of the (i−11)^{th} installation interface;

2) controlling the cutting origin to advance in a predetermined direction at the i^{th} cutting speed; and

3) completing the i^{th} cutting operation when the cutting origin arrives at another boundary of the (i−1)^{th} installation interface.

The terminal determines one boundary of the (i−1)^{th} installation interface according to a predetermined algorithm, generates a cutting origin in a predetermined location on the boundary, controls the cutting origin to advance in a predetermined direction at the i^{th} cutting speed; and forms a cutting line between a start point and an endpoint of the cutting origin when the cutting origin arrives at another boundary of the (i−1)^{th} installation interface, where the cutting line cuts the (i−1)^{th} installation interface into two interfaces, thereby completing the i^{th} cutting operation.

A process in which the cutting origin advances in the predetermined direction may be a preset video. The terminal needs to adjust a playback speed of the video according to the i^{th} cutting speed, so as to play the video in the (i−1)^{th} installation interface at the adjusted playback speed. Because a video can attract attention of a user and avoid a feeling of waiting caused when the user pays attention to the progress bar, user experience is improved.

Step 203: Determine a reserved i^{th} installation interface after the i^{th} cutting operation is completed.

The terminal may acquire the two interfaces obtained by means of cutting, and select one interface from the two interfaces as the reserved i^{th} installation interface; or the terminal may store installation interfaces, find an installation interface corresponding to the i^{th} cutting from the stored installation interfaces after the i^{th} cutting operation is completed, and determine that the installation interface is the reserved i^{th} installation interface.

Step 204: Replace the (i−1)^{th} installation interface with the i^{th} installation interface, and present the i^{th} installation interface.

The terminal presents the acquired i^{th} installation interface to replace the (i−1)^{th} installation interface presented formerly.

Generally, in the process of installing the application program, the terminal acquires the installation progress of the application program in real time, and draws the installation progress acquired each time into the progress bar of the installation interface and presents the installation progress. A process of drawing for multiple times by the terminal consumes a great number of processing resources of the terminal. Therefore, in this embodiment, an installation interface is gradually decreased by cutting the installation interface of the application program, and a speed of an installation progress is embodied by using a size of the installation interface. Because the number of times of replacing the installation interface is much less than the number of times of drawing the installation progress into a progress bar, this embodiment can save the processing resources of the terminal.

Step 205: Update i with i+1, and proceed to perform the step of performing an i^{th} cutting operation on an (i−1)^{th} installation interface of an application program.

When i<j, i is updated with i+1, and the performing the i^{th} cutting operation on the (i−1)^{th} installation interface proceeds; and when i=j, i is updated with a value of i+1 and the value is greater than j. At this moment, a cutting process ends.

It should be supplemented that the method further includes:

1) detecting whether the application program completes installation every other predetermined time, and detecting whether what is presented is a j^{th} installation interface every other predetermined time; and

2) playing a predetermined video cyclically on the j^{th} installation interface if it is detected that the application program does not complete the installation and what is presented is the j^{th} installation interface.

If the terminal currently presents the j^{th} installation interface, because the j^{th} installation interface is the last installation interface in the cutting process, it can be determined that the cutting process ends; and if the application program still does not complete the installation at this moment, the terminal can play the predetermined video on the j^{th} installation interface to attract attention of a user by using the predetermined video, so as to reduce the feeling of waiting of the user. If the application program still does not complete the installation after the predetermined video completes playback, the terminal can play the predetermined video cyclically till the terminal detects that the application program completes the installation and stops playing the predetermined video.

The installation interface is formed by a base map and elements added to the base map. Therefore, when the predetermined video is played on the j^{th} installation interface, the terminal may add the predetermined video to the base map of the j^{th} installation interface by using the predetermined video as an element, and play the predetermined video. The terminal may further modify another element on the base map of the j^{th} installation interface.

If the terminal currently presents the i^{th} (i<j) installation interface, it is determined that the cutting process has not ended yet; and if the application program completes the installation at this moment, the terminal can increase a cutting speed of each subsequent cutting operation, so as to complete the cutting process as soon as possible.

Further, after the detecting whether the application program completes installation every other predetermined time, and detecting whether what is presented is a j^{th} installation interface, the method further includes:

1) generating an application interface of the application program if it is detected that the application program completes the installation and what is presented is the j^{th} installation interface, where an interface size of the application interface is the same as that of the j^{th} installation interface; and

2) presenting various functions provided by the application program on the application interface.

If the terminal currently presents the j^{th} installation interface, it is determined that the cutting process ends; and if the application program completes the installation at this moment, the terminal may generate the application interface of the application program and present the various functions provided by the application program on the application interface. The application interface is an interface that presents the various functions of the application program in the terminal in the process of running the application program. For example, if the application program is security software, the application interface can present an antivirus function, a garbage cleaning function, a terminal accelerating function, a software management function, a toolkit function, and the like.

The terminal may further set the interface size of the application interface to be the same as that of the j^{th} installation interface, so as to embody features of smallness and lightness of the application program by using a small interface obtained by means of cutting. Specifically, because the application interface is small, the application interface presents important functions of the application program. Moreover, unimportant functions are blocked, so that the application program is light, and operation complexity of the application program can also be reduced.

It should be supplemented that in order to enable the user to know the installation progress of the application program, the terminal may further acquire the installation progress every other predetermined time, and present the installation progress on the installation interface in a form of words.

For ease of understanding, this embodiment describes the installation interface presentation method by using that the application program is the security software as an example, and details are as follows.

1.When the terminal runs an installation package of the security software, a schematic diagram of a first interface of an installation interface presentation method shown in FIG. 2B is presented. FIG. 2B presents information such as an icon, a use protocol, and an installation type of the security software. If a user checks “agree with the use protocol”, a “find out” button in FIG. 2B is modified from an unclickable state to a clickable state, and the user clicks the “find out” button to start to install the security software.

2. In a process of installing the security software, a schematic diagram of a second interface of an installation interface presentation method shown in FIG. 2C is presented. If it is determined that an interface presented in FIG. 2C is the zeroth installation interface, a black dot in the figure is the cutting origin of the 1^{st} cutting operation set by the terminal, and the cutting origin starts to advance downward at a speed of x cm/s along a perpendicular direction from an upper boundary of the zeroth installation interface.

3. When the cutting origin of the 1^{st} cutting operation arrives at a lower boundary of the zeroth installation interface, the 1^{st} cutting operation is completed. The zeroth installation interface is replaced with the obtained 1^{st} installation interface, and the 1^{st} installation interface is presented. The terminal proceeds to perform the 2^{nd} cutting operation on the 1^{st} installation interface, and a schematic diagram of a third interface of an installation interface presentation method shown in FIG. 2D is presented. A black dot in FIG. 2D is the cutting origin of the 2^{nd} cutting operation set by the terminal, and the cutting origin starts to advance to the right at a speed of 0.3x cm/s along a horizontal direction from a left boundary of the 1^{st} installation interface.

4. When the cutting origin of the 2^{nd} cutting operation arrives at a right boundary of the 1^{st} installation interface, the 2^{nd} cutting operation is completed. The 1^{st} installation interface is replaced with the obtained 2^{nd} installation interface, and the 2^{nd} installation interface is presented. The terminal proceeds to perform the 3^{rd} cutting operation on the 2^{nd} installation interface, and a schematic diagram of a fourth interface of an installation interface presentation method shown in FIG. 2E is presented. A black dot in FIG. 2E is the cutting origin of the 3^{rd} cutting operation set by the terminal, and the cutting origin starts to advance downward at a speed of 0.5x cm/s along a perpendicular direction from an upper boundary of the 2^{nd} installation interface.

5. When the cutting origin of the 3^{rd} cutting operation arrives at a lower boundary of the 2^{nd} installation interface, the 3^{rd} cutting operation is completed. The 2^{nd} installation interface is replaced with the obtained 3^{rd} installation interface, and the 3^{rd} installation interface is presented. The terminal proceeds to perform the 4^{th} cutting operation on the 3^{rd} installation interface, and a schematic diagram of a fifth interface of an installation interface presentation method shown in FIG. 2F is presented. A black dot in FIG. 2F is the cutting origin of the 4^{th} cutting operation set by the terminal, and the cutting origin starts to advance to the right at a speed of 2x cm/s along a horizontal direction from a left boundary of the 3^{rd} installation interface.

6. When the cutting origin of the 4^{th} cutting operation arrives at a right boundary of the 3^{rd} installation interface, the 4^{th} cutting operation is completed. The 3^{rd} installation interface is replaced with the obtained 4^{th} installation interface, and the 4^{th} installation interface is presented. If the terminal detects that the security software does not complete the installation, the terminal reserves a base map of the 4^{th} installation interface, modifies an element presented on the base map, and implements cyclic playback of a video on the 4^{th} installation interface. A schematic diagram of a sixth interface of an installation interface presentation method shown in FIG. 2G is presented. Over an icon in FIG. 2G is a line of a predetermined length, and the video may be that the line moves around the icon.

7. If the terminal detects that the installation of the security software is completed, the terminal still reserves the base map of the 4^{th} installation interface, and modifies the element presented on the 4^{th} installation interface again to obtain a schematic diagram of a seventh interface of an installation interface presentation method shown in FIG. 2H. If the user clicks a “start to experience” button, the terminal presents an application interface of the security software.

8. Referring to a schematic diagram of an eighth interface of an installation interface presentation method shown in FIG. 2I, FIG. 2I presents functions of the security software. Four icons from left to right sequentially represent an antivirus function, a garbage cleaning function, a terminal accelerating function, and a toolkit function. If the user clicks a “fully experience” button, the terminal presents a conventional application interface of the security software, where the conventional application interface is an application interface of the security software provided by the existing technology.

In summary, in the installation interface presentation method according to this embodiment of the present invention, an i^{th} cutting operation is performed on an (i−1)^{th} installation interface of an application program in a process of installing the application program; a reserved i^{th} installation interface is determined after the i^{th} cutting operation is completed; the (i−1)^{th} installation interface is replaced with the i^{th} installation interface, and the i^{th} installation interface is presented; and i is updated with i+1, and the step of performing an i^{th} cutting operation on an (i−1)^{th} installation interface of an application program proceeds to be performed. An installation interface can be gradually decreased by cutting the installation interface of the application program, and a speed of an installation progress is embodied by using a size of the installation interface. Because the number of times of replacing the installation interface is much less than the number of times of drawing the installation progress into a progress bar, a problem of consuming a great number of processing resources of a terminal when the terminal draws the installation progress of the application program into the progress bar for multiple times is solved, and an effect of saving the processing resources of the terminal is achieved.

Moreover, the installation progress of the application program is acquired; the second correspondence is searched for a cutting speed corresponding to the installation progress; and it is determined that the found cutting speed is the i^{th} cutting speed correspond to the i^{th} cutting operation. The cutting speed may be adjusted according to the installation progress, so that an installation interface obtained by means of cutting at the adjusted cutting speed is more approximate to the installation progress, and accuracy of cutting is improved.

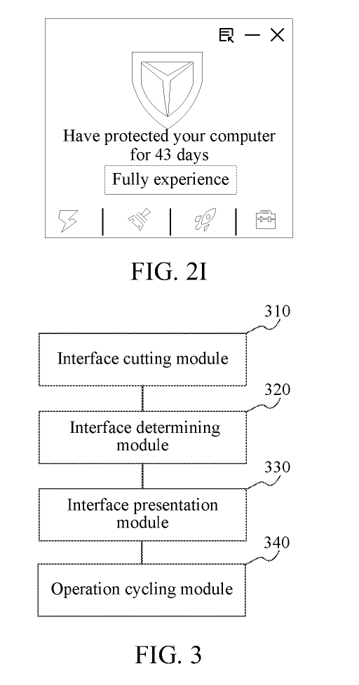

Referring to FIG. 3, FIG. 3 shows a structural block diagram of an installation interface presentation apparatus according to an embodiment of the present invention. The installation interface presentation apparatus can be applied to a terminal, where the terminal may be a smart TV, a smartphone, a tablet computer, or the like. The installation interface presentation apparatus includes:

an interface cutting module 310, configured to perform an i^{th} cutting operation on an (i−1)^{th} installation interface of an application program in a process of installing the application program, where 1≦i≦j;

an interface determining module 320, configured to determine a reserved i^{th} installation interface after the interface cutting module 310 completes the i^{th} cutting operation;

an interface presentation module 330, configured to replace the (i−1)^{th} installation interface with the i^{th} installation interface determined by the interface determining module 320, and present the i^{th} installation interface; and an operation cycling module 340, configured to update i with i+1, and proceed to perform the operation of performing an i^{th} cutting operation on an (i−1)^{th} installation interface of an application program.

In summary, in the installation interface presentation apparatus according to this embodiment of the present invention, an i^{th} cutting operation is performed on an (i−1)^{th} installation interface of an application program in a process of installing the application program; a reserved i^{th} installation interface is determined after the i^{th} cutting operation is completed; the (i−1)^{th} installation interface is replaced with the i^{th} installation interface, and the i^{th} installation interface is presented; and i is updated with i+1, and the step of performing an i^{th} cutting operation on an (i−1)^{th} installation interface of an application program proceeds to be performed. An installation interface can be gradually decreased by cutting the installation interface of the application program, and a speed of an installation progress is embodied by using a size of the installation interface. Because the number of times of replacing the installation interface is much less than the number of times of drawing the installation progress into a progress bar, a problem of consuming a great number of processing resources of a terminal when the terminal draws the installation progress of the application program into the progress bar for multiple times is solved, and an effect of saving the processing resources of the terminal is achieved.

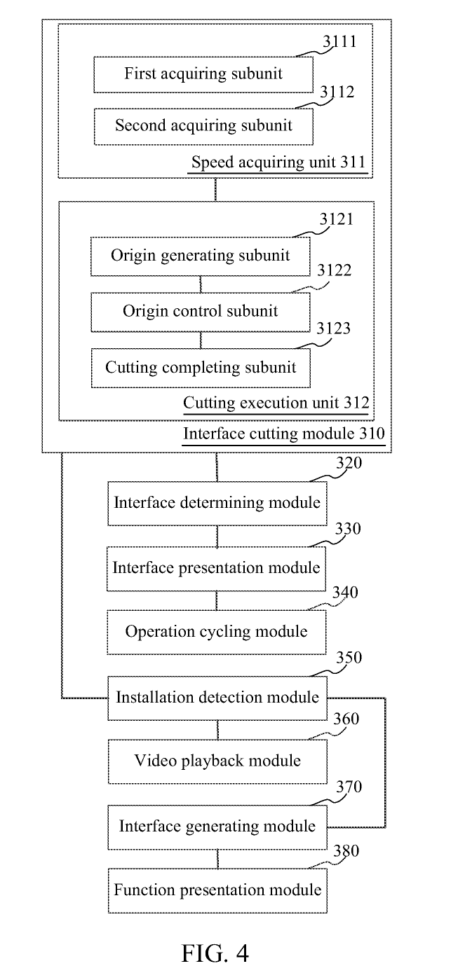

Referring to FIG. 4, FIG. 4 shows a structural block diagram of an installation interface presentation apparatus according to another embodiment of the present invention. The installation interface presentation apparatus can be applied to a terminal, where the terminal may be a smart TV, a smartphone, a tablet computer, or the like. The installation interface presentation apparatus includes: an interface cutting module 310, an interface determining module 320, an interface presentation module 330, and an operation cycling module 340.

The interface cutting module 310 is configured to perform an i^{th} cutting operation on an (i−1)^{th} installation interface of an application program in a process of installing the application program, where 1≦i≦j.

The interface determining module 320 is configured to determine a reserved i^{th} installation interface after the interface cutting module 310 completes the i^{th} cutting operation.

The interface presentation module 330 is configured to replace the (i−1)^{th} installation interface with the i^{th} installation interface determined by the interface determining module 320, and present the i^{th} installation interface.

The operation cycling module 340 is configured to update i with i+1, and proceed to perform the operation of performing an i^{th} cutting operation on an (i−1)^{th} installation interface of an application program.

The interface cutting module 310 includes:

a speed acquiring unit 311, configured to acquire an i^{th} cutting speed corresponding to the i^{th} cutting operation; and

a cutting execution unit 312, configured to perform the i^{th} cutting operation on the (i−1)^{th} installation interface according to the i^{th} cutting speed acquired by the speed acquiring unit 311, where

the i^{th} cutting speed when i≦m is greater than the i^{th} cutting speed when m<i<n; and/or

the i^{th} cutting speed when i≧n is greater than the i^{th} cutting speed when m<i<n, where m≧1 and n≦j.

The speed acquiring unit 311 includes:

a first acquiring subunit 3111, configured to search a first correspondence for a cutting speed corresponding to i, and determine that the found cutting speed is the i^{th} cutting speed correspond to the i^{th} cutting operation; and/or

a second acquiring subunit 3112, configured to acquire an installation progress of the application program, search a second correspondence for a cutting speed corresponding to the installation progress, and determine that the found cutting speed is the i^{th} cutting speed correspond to the i^{th} cutting operation.

The cutting execution unit 312 includes:

an origin generating subunit 3121, configured to generate a cutting origin in a predetermined location on one boundary of the (i−1)^{th} installation interface;

an origin control subunit 3122, configured to control the cutting origin generated by the origin generating subunit 3121 to advance in a predetermined direction at the i^{th} cutting speed; and

a cutting completing subunit 3123, configured to complete the i^{th} cutting operation when the origin control subunit 3122 controls the cutting origin to arrive at another boundary of the (i−1)^{th} installation interface.

The apparatus further includes:

an installation detection module 350, configured to detect whether the application program completes installation every other predetermined time, and detect whether what is presented is a j^{th} installation interface every other predetermined time; and

a video playback module 360, configured to play a predetermined video cyclically on the j^{th} installation interface if the installation detection module 350 detects that the application program does not complete the installation and what is presented is the j^{th} installation interface.

The apparatus further includes:

an interface generating module 370, configured to, after the installation detection module 350 detects whether the application program completes the installation every other predetermined time, and detects whether what is presented is the j^{th} installation interface, generate an application interface of the application program when it is detected that the application program completes the installation and what is presented is the j^{th} installation interface, where an interface size of the application interface is the same as that of the j^{th} installation interface; and

a function presentation module 380, configured to present various functions provided by the application program on the application interface generated by the interface generating module 370.

In summary, in the installation interface presentation apparatus according to this embodiment of the present invention, an i^{th} cutting operation is performed on an (i−1)^{th} installation interface of an application program in a process of installing the application program; a reserved i^{th} installation interface is determined after the i^{th} cutting operation is completed; the (i−1)^{th} installation interface is replaced with the i^{th} installation interface, and the i^{th} installation interface is presented; and i is updated with i+1, and the step of performing an i^{th} cutting operation on an (i−1)^{th} installation interface of an application program proceeds to be performed. An installation interface can be gradually decreased by cutting the installation interface of the application program, and a speed of an installation progress is embodied by using a size of the installation interface. Because the number of times of replacing the installation interface is much less than the number of times of drawing the installation progress into a progress bar, a problem of consuming a great number of processing resources of a terminal when the terminal draws the installation progress of the application program into the progress bar for multiple times is solved, and an effect of saving the processing resources of the terminal is achieved.

Moreover, the installation progress of the application program is acquired; the second correspondence is searched for a cutting speed corresponding to the installation progress; and it is determined that the found cutting speed is the i^{th} cutting speed correspond to the i^{th} cutting operation. The cutting speed may be adjusted according to the installation progress, so that an installation interface obtained by means of cutting at the adjusted cutting speed is more approximate to the installation progress, and accuracy of cutting is improved.

It should be noted that division of the above functional modules is only described for exemplary purposes when the installation interface presentation apparatus provided by the foregoing embodiment presents an installation interface. In actual applications, the functions may be allocated to and implemented by different functional modules as required, which means that the internal structure of the installation interface presentation apparatus is divided into different functional modules to complete all or some of the above described functions. In addition, the installation interface presentation apparatus that is provided by the foregoing embodiments is based on the same concept as the installation interface presentation method in the foregoing embodiments. For the specific implementation process, refer to the method embodiments, and the details are not described herein again.

The sequence numbers of the foregoing embodiments of the present invention are merely for the purpose of description, and do not imply the preference among the embodiments.

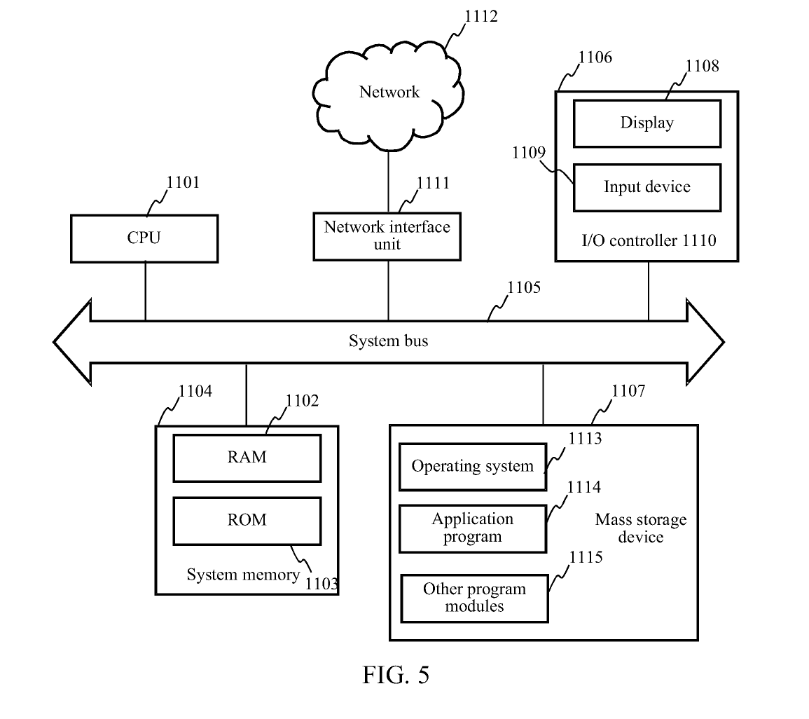

Referring to FIG. 5, FIG. 5 shows a structural block diagram of an installation interface presentation apparatus 1100 according to an embodiment of the present invention. The installation interface presentation apparatus 1100 can be applied to a terminal, where the terminal may be a smart TV, a smartphone, a tablet computer, or the like. The installation interface presentation apparatus 1100 includes a central processing unit (CPU) 1101, a system memory 1104 that includes a random access memory (RAM) 1102 and a read-only memory (ROM) 1103, and a system bus 1105 connecting the system memory 1104 and the CPU 1101. The installation interface presentation apparatus 1100 further includes a basic input/output system (I/O system) 1106 that helps components in a computer transmit information between each other, and a mass storage device 1107 configured to store an operating system 1113, an application program 1114, and other program modules 1115.

The basic I/O system 1106 includes a display 1108 configured to display information and an input device 1109 configured to allow a user to input information, such as a mouse or a keyboard. The display 1108 and the input device 1109 are both connected to the CPU 1101 by means of an input/output (I/O) controller 1110 connected to the system bus 1105. The basic I/O system 1106 may further include the I/O controller 1110 configured to receive and process inputs from multiple other devices such as a keyboard, a mouse, and an electronic stylus. Similarly, the I/O controller 1110 also provides an output to a display screen, a printer or other types of output devices.

The mass storage device 1107 is connected to the CPU 1101 by means of a mass storage controller (not shown) connected to the system bus 1105. The mass storage device 1107 and a related computer readable medium provide nonvolatile storage for the installation interface presentation apparatus 1100. That is, the mass storage device 1107 may include a computer readable medium (not shown) such as a hard disk or a CD-ROM driver.

Without loss of generality, the computer readable medium may include a computer storage medium and a communication medium. The computer storage medium includes volatile and nonvolatile, removable and non-removable media implemented by any method or technology used for storing information such as a computer readable instruction, a data structure, a program module or other data. The computer storage medium includes a RAM, a ROM, an EPROM, an EEPROM, a flash memory or other solid-state storage; a CD-ROM, a DVD or other optical storage; and a cassette, a magnetic tape, a magnetic disk storage or other magnetic storage devices. Certainly, a person skilled in the art may know that the computer storage medium is not limited to those media described above. The system memory 1104 and the mass storage device 1107 may be collectively referred to as a memory.

According to various embodiments of the present invention, the installation interface presentation apparatus 1100 may further be connected to a remote computer on a network for running via a network such as the Internet. That is, the installation interface presentation apparatus 1100 may be connected to a network 1112 by means of a network interface unit 1111 connected to the system bus 1105, or the installation interface presentation apparatus 1100 may also be connected to other types of networks or remote computer systems (not shown) by means of the network interface unit 1111.

The memory further includes one or more programs. The one or more programs are stored in the memory, and the one or more programs contain instructions used for performing the installation interface presentation method according to the embodiments of the present invention.

A person of ordinary skill in the art may understand that all or some of the steps of the foregoing embodiments may be implemented by using hardware, or may be implemented by a program instructing relevant hardware. The program may be stored in a computer readable storage medium. The aforementioned storage medium may be a read-only memory, a magnetic disk, an optical disc, or the like.

The foregoing descriptions are merely preferred embodiments of the present invention, but are not intended to limit the present disclosure. Any modification, equivalent replacement, or improvement made within the spirit and principle of the present disclosure shall fall within the protection scope of the present disclosure.

1. An installation interface presentation method, comprising:
performing an i^{th} cutting operation on an (i−1)^{th} installation interface of an application program in a process of installing the application program, 1≦i≦j;
determining a reserved i^{th} installation interface after the i^{th} cutting operation is completed;
replacing the (i−1)^{th} installation interface with the i^{th} installation interface, and presenting the i^{th} installation interface; and
updating i with i+1, and proceeding to perform the step of performing an i^{th} cutting operation on an (i−1)^{th} installation interface of an application program.

2. The method according to claim 1, wherein the performing an i^{th} cutting operation on an (i−1)^{th} installation interface of an application program comprises:
acquiring an i^{th} cutting speed corresponding to the i^{th} cutting operation; and
performing the i^{th} cutting operation on the (i−1)^{th} installation interface according to the i^{th} cutting speed, wherein
the i^{th} cutting speed when i≦m is greater than the i^{th} cutting speed when m<i<n and/or
the i^{th} cutting speed when i≧n is greater than the i^{th} cutting speed when m<i<n, wherein m≧1 and n≦j.

3. The method according to claim 2, wherein the acquiring an i^{th} cutting speed corresponding to the i^{th} cutting operation comprises:
searching a first correspondence for a cutting speed corresponding to i, and determining that the found cutting speed is the i^{th} cutting speed correspond to the i^{th} cutting operation; and/or
acquiring an installation progress of the application program, searching a second correspondence for a cutting speed corresponding to the installation progress, and determining that the found cutting speed is the i^{th} cutting speed correspond to the i^{th} cutting operation.

4. The method according to claim 2, wherein the performing the i^{th} cutting operation on the (i−1)^{th} installation interface according to the i^{th} cutting speed comprises:
generating a cutting origin in a predetermined location on one boundary of the (i−1)^{th} installation interface;
controlling the cutting origin to advance in a predetermined direction at the i^{th} cutting speed; and
completing the i^{th} cutting operation when the cutting origin arrives at another boundary of the (i−1)^{th} installation interface.

5. The method according to claim 1, comprising:
detecting whether the application program completes installation every other predetermined time, and detecting whether what is presented is a j^{th} installation interface every other predetermined time; and
playing a predetermined video cyclically on the j^{th} installation interface if it is detected that the application program does not complete the installation and what is presented is the j^{th} installation interface.

6. The method according to claim 5, wherein after the detecting whether the application program completes installation every other predetermined time, and detecting whether what is presented is a j^{th} installation interface, the method comprises:
generating an application interface of the application program if it is detected that the application program completes the installation and what is presented is the j^{th} installation interface, wherein an interface size of the application interface is the same as that of the j^{th} installation interface; and
presenting various functions provided by the application program on the application interface.

7. An installation interface presentation apparatus, comprising:
one or more processors;
memory; and
a plurality of program modules stored in the memory and to be executed by the one or more processors, the plurality of program modules comprising:
an interface cutting module, configured to perform an i^{th} cutting operation on an (i−1)^{th} installation interface of an application program in a process of installing the application program, 1≦i≦j;
an interface determining module, configured to determine a reserved i^{th} installation interface after the interface cutting module completes the i^{th} cutting operation;
an interface presentation module, configured to replace the (i−1)^{th} installation interface with the i^{th} installation interface determined by the interface determining module, and present the i^{th} installation interface; and
an operation cycling module, configured to update i with i+1, and proceed to perform the operation of performing an i^{th} cutting operation on an (i−1)^{th} installation interface of an application program.

8. The apparatus according to claim 7, wherein the interface cutting module comprises:
a speed acquiring unit, configured to acquire an i^{th} cutting speed corresponding to the i^{th} cutting operation; and
a cutting execution unit, configured to perform the i^{th} cutting operation on the (i−1)^{th} installation interface according to the i^{th} cutting speed acquired by the speed acquiring unit, wherein
the i^{th} cutting speed when i≦m is greater than the i^{th} cutting speed when m<i<n; and/or
the i^{th} cutting speed when i≧n is greater than the i^{th} cutting speed when m<i<n, wherein m≧1 and n≦j.

9. The apparatus according to claim 8, wherein the speed acquiring unit comprises:
a first acquiring subunit, configured to search a first correspondence for a cutting speed corresponding to i, and determine that the found cutting speed is the i^{th} cutting speed correspond to the i^{th} cutting operation; and/or
a second acquiring subunit, configured to acquire an installation progress of the application program, search a second correspondence for a cutting speed corresponding to the installation progress, and determine that the found cutting speed is the i^{th} cutting speed correspond to the i^{th} cutting operation.

10. The apparatus according to claim 8, wherein the cutting execution unit comprises:
an origin generating subunit, configured to generate a cutting origin in a predetermined location on one boundary of the (i−1)^{th} installation interface;
an origin control subunit, configured to control the cutting origin generated by the origin generating subunit to advance in a predetermined direction at the i^{th} cutting speed; and
a cutting completing subunit, configured to complete the i^{th} cutting operation when the origin control subunit controls the cutting origin to arrive at another boundary of the (i−1)^{th} installation interface.

11. The apparatus according to claim 7, comprising:
an installation detection module, configured to detect whether the application program completes installation every other predetermined time, and detect whether what is presented is a j^{th} installation interface every other predetermined time; and
a video playback module, configured to play a predetermined video cyclically on the j^{th} installation interface if the installation detection module detects that the application program does not complete the installation and what is presented is the j^{th} installation interface.

12. The apparatus according to claim 11, wherein the plurality of program modules comprises:
an interface generating module, configured to, after the installation detection module detects whether the application program completes the installation every other predetermined time, and detects whether what is presented is the j^{th} installation interface, generate an application interface of the application program when it is detected that the application program completes the installation and what is presented is the j^{th} installation interface, wherein an interface size of the application interface is the same as that of the j^{th} installation interface; and
a function presentation module, configured to present various functions provided by the application program on the application interface generated by the interface generating module.

13. A computer readable storage medium storing a computer executable instruction, when executed by a processor, the computer executable instruction performing an installation interface presentation method, the installation interface presentation method comprising:
performing an i^{th} cutting operation on an (i−1)^{th} installation interface of an application program in a process of installing the application program, 1≦i≦j;
determining a reserved i^{th} installation interface after the i^{th} cutting operation is completed;
replacing the (i−1)^{th} installation interface with the i^{th} installation interface, and presenting the i^{th} installation interface; and
updating i with i+1, and proceeding to perform the step of performing an i^{th} cutting operation on an (i−1)^{th} installation interface of an application program.

14. The computer readable storage medium according to claim 13, wherein the performing an i^{th} cutting operation on an (i−1)^{th} installation interface of an application program comprises:
acquiring an i^{th} cutting speed corresponding to the i^{th} cutting operation; and
performing the i^{th} cutting operation on the (i−1)^{th} installation interface according to the i^{th} cutting speed, wherein
the i^{th} cutting speed when i≦m is greater than the i^{th} cutting speed when m<i<n; and/or
the i^{th} cutting speed when i≧n is greater than the i^{th} cutting speed when m<i<n, wherein m≧1 and n≦j.

15. The computer readable storage medium according to claim 14, wherein the acquiring an i^{th} cutting speed corresponding to the i^{th} cutting operation comprises:
searching a first correspondence for a cutting speed corresponding to i, and determining that the found cutting speed is the i^{th} cutting speed correspond to the i^{th} cutting operation; and/or
acquiring an installation progress of the application program, searching a second correspondence for a cutting speed corresponding to the installation progress, and determining that the found cutting speed is the i^{th} cutting speed correspond to the i^{th} cutting operation.

16. The computer readable storage medium according to claim 14, wherein the performing the i^{th} cutting operation on the (i−1)^{th} installation interface according to the i^{th} cutting speed comprises:
generating a cutting origin in a predetermined location on one boundary of the (i−1)^{th} installation interface;
controlling the cutting origin to advance in a predetermined direction at the i^{th} cutting speed; and
completing the i^{th} cutting operation when the cutting origin arrives at another boundary of the (i−1)^{th} installation interface.

17. The computer readable storage medium according to claim 13, wherein the method further comprises:
detecting whether the application program completes installation every other predetermined time, and detecting whether what is presented is a j^{th} installation interface every other predetermined time; and
playing a predetermined video cyclically on the j^{th} installation interface if it is detected that the application program does not complete the installation and what is presented is the j^{th} installation interface.

18. The computer readable storage medium according to claim 17, wherein after the detecting whether the application program completes installation every other predetermined time, and detecting whether what is presented is a j^{th} installation interface, the method further comprises:
generating an application interface of the application program if it is detected that the application program completes the installation and what is presented is the j^{th} installation interface, wherein an interface size of the application interface is the same as that of the j^{th} installation interface; and
presenting various functions provided by the application program on the application interface.
